(19) United States
(12) Patent Application Publication
(10) Pub. No.: US 2015/0037773 A1
(43) Pub. Date: Feb. 5, 2015

(54) Tissue-Simulation Device for Learning and Training in Basic Techniques of Laparoscopic, Endoscopic or Minimally-Invasive Surgery

(71) Applicant: Cesar Quirarte Catano, Naucalpan (MX)

(72) Inventor: Cesar Quirarte Catano, Naucalpan (MX)

(21) Appl. No.: 14/349,831

(22) PCT Filed: Oct. 6, 2011
(86) PCT No.: PCT/MX2011/000118

§ 371 Date: Apr. 4, 2014

(51) Int. Cl. G09B 23/28

(52) U.S. Cl. CPC G09B 23/285
USPC 434/262

(57) ABSTRACT

The simulator device of the present invention has been created ex profeso for being applied in the learning, training and evaluation, mainly of basic techniques of surgery, particularly laparoscopic, endoscopic or minimal invasion techniques, and the use of specialized instruments. It includes a variety of modules or components capable of being assembled into different shapes so as to erect or mount different working stations, specific for different practice exercises, such an incision, manipulation of object, forming suture stitches and surgical knots, as well as other exercises.

### FIELD OF THE INVENTION

This invention relates to a modular simplified device capable of being assembled, for simulating tissues, in the learning and practice of the basic surgery abilities, particularly laparoscopic surgery, also known as endoscopic surgery or minimal invasion surgery, and likewise this invention can be used on any of the “endotrainers” o box trainers already existing.

### BACKGROUND OF THE INVENTION

Contrary to the traditional or “open” surgery, carried out through broad incisions and under direct vision, modern laparoscopic surgery consists in carrying out said surgical interventions through small incisions, also known as “ports”, through which the different anatomic cavities are accessed, mainly the abdominal cavity and thoracic cavity. Said ports of entrance enable the introduction of new, elongated and thin surgical instruments. Through one of said ports a fine instrument so-called endoscope or laparoscope is introduced, provided with a video capture system wherein the image, transmitted in closed circuit and projected onto a screen, allows for the surgeon and the assistants to guide their movements and maneuvers during the surgical intervention.

This technological and instrumental “interface” of laparoscopic surgery modifies the sensorial relationship of the surgeons with the tissues and organs, changes drastically the special visual context and requires the mastering of new and complex manual skills, including the use of instruments with designs and mechanisms of action different from those used with the traditional or open surgery.

Due to the above, someone in the process of become an endoscopy surgeon must go through a psychomotor training process through training with surgical simulators before he or she may be able to carry out surgical procedures on a patient.

Aside from the traditional biologic simulators with corpse or anesthetized living animals, different types of simulators have been developed, from the “box-type” simpler ones, also named of “first generation”, also known as “endotrainers”, up to those of “virtual reality” more technologically sophisticated, also known as “second generation”. Each of said simulator types and models has a determined application, depending on the technique, the maneuver or procedure to be practiced therein.

This invention corresponds to the “first generation” and is a simulator of tissues, addressed to the practice of techniques and routines known as basic or fundamental of general surgery, particularly laparoscopic or endoscopic surgeries. Said basic techniques are incision, dissection (separation apart of tissues), hemostasis (hemorrhage control) and suture, wherein the maneuvers and routines a surgeon must expertly practice are those of cutting, the delicate manipulation of objects, the application of sutures and surgical knots, by skillfully using the dedicated instrumental, for which other preparatory exercises are effected.

The simulator in use, on the one side, must mimic the tissues and organs on which the different maneuvers are to be carried out and, on the other side, must reproduce the closed context of the endoscopic surgery whereby said simulated tissue is to be incorporated at the interior of some of the available “box” or “endotrainer” apparatuses, thus conforming a simulator system suitable for the practice of said basic techniques.

There are a number of patent documents describing simulator devices or apparatus to practice endoscopic surgery, wherein different types of training boxes or the like are revealed, with or without mirror or video systems or other complex mechanic and electronic mechanisms, often provided with some metal mechanisms for fastening, tightening and stretching simulated tissues.

Some of said patent documents are directed to the use of vegetal tissues or fresh animal viscera, further to synthetic accessories simulating “skin” or “tissue”, but without a detailed disclosure thereof and with no claim for them.

On the other side, commercial advertisement exhibits the following products as characteristic examples:

Real System offers two complex models of simulator of the training box type, with interior lights and CCT system. The simpler one, so-called LTB and a more sophisticated (LTS) one disclosed in US Patent No. 016668ZA1, Jul. 19, 2007, include a computer, a keyboard, a software and electronic sensors for time and movements registration and measurement. Both incorporate hybrid attachments for different exercises; the first one on a plastic tray and the second one on a rotatory carrousel successively presenting the various working stations. The practice attachment include “Velcro” and clamps to support other elements such as poles, nails, small cups, beads, strings, rings, stakes, pipe cleaners, silastic and latex tubes and other elements for several exercises; wire hooks for passing washers or rings, latex or silastic tubes for cannulation, textiles and plastic foam for cutting and other further parts manufactured from different materials.

Simulab Co. commercializes an endotrainer and various practice kits for both open basic surgery and gyneco obstetrics, and for laparoscopic surgery, provided as a tray, with support integrated methods including alligator-type clamps, flat pieces manufactured from different embossed plastics reproducing certain viscera; plastic foams, latex tubes and other rubber and textile materials.

3-Dmed®; “Limbs and Things”; Sichuan Province Shengyuan Medical Devices Co., LTD, are corporations that commercialize various endotrainers and different kits to practice laparoscopic skills, including several rigid plastic boards with ringbolts and metal hooks, stakes and hollow rings or cylinders to be inserted, alligator-type plastic and metal clamps “Velcro”, clips, plastic foamed materials, latex tuber, textile gauze and other semi-rigid embossed plastics that mimic tissues or anatomic elements. 3Dmed® also offers a kit specifically dedicated to the practice of fundamental skills (FLS) “FLS-PB09” (“POractice Board for FLS Skills”) consisting of, as the above, different parts made from different materials.

There are a profusion of documents relating medical and surgical literature in connection with virtual reality simulators, basically related to the importance and utility of different exercises to be practiced with simulators, and are directed mainly to the aspects of reliability, didactic utility statistics and measurement parameters validation, for both the apprentice feedback and certification and marking purposes. Particularly exercises for training the fundamental skills in laparoscopic or endoscopic surgery have been disclosed and standardized in the world over and medical literature refers the training devices in connection to their didactic reliability.

On this line, taking into account that practice on surgical simulators is a teaching tool, there are three of said training and evaluating methods using physical objects of tissues to practice basic skills, that have been evaluated and subjected to a number of statistics validation tests, both as efficient didactic and reliable evaluation instruments: EI ISCAD (Imperial College Surgical Assessment Device), developed in England by the Royal College of Surgeons; one preconized by James Rosser, named “Top Gun Laparoscopic Training” in the United States, and one known as MISTELS (“McGill Inanimate System for Training and Evaluation of Laparoscopic Skills”).

This latter, developed at the McGill University in Canada and incorporated in the SAGES (“Society of American Gastrointestinal and Endoscopic Surgeons”) FLS (“Fundamental Laparoscopic Skills”) program, has been recognized and sponsored also by the ACS (“American College of Surgeons”). Passing the FLS program is mandatory for certification by both “American Board of Surgery” and “American Board of Colon and Rectal Surgery”.

Said training models, as well as other ones use a diversity of objects and materials to conform different practice stations. Rosser model (“Top Gun”) includes several elements: For practice of object transference and visual spatial orientation there are: a chess-type board with printed numbers and letters, wherein under certain order there are arranged separated plastic pieces also provided with numbers and letters; a kit of a broad mouth cup and a narrow copper container and beans to be passed from the former to the latter, and a string with transversal marks to be passed from a laparoscopic clamp to another and then winded in a skein, so-called the “cobra exercise”. For suture practice a triangle section block of plastic foam is provided, at the edges of which sutures and knots practices are effected.

FLS program is internationally recognized as a paradigm and a reference for education and basic training in this field and, therefore, FLS system is the most used and recommended by surgical education instances in the world. Said system comprises a part of theoretical knowledge and another of basic or fundamental manual skills employing a standardized set of simulation materials, which is precisely of interest for us as a prior art.

From the point of view of the state of the art as discussed above, we consider FLS program and the simulation materials thereof as the most important reference in our project.

Said tissue simulator device, preconized and distributed by FLS program (http://www.flsprogram.org) consists of a half-closed box with a closed-circuit video system and a Kit of elements or simulator for the practice of fundamental skills, comprising:
a staked board and a 6-ring or cylinder kit of rigid plastic for the transference exercise;
a package of 50 gauze pieces with drawn patterns thereon, for cutting practice;
Various (3) soft plastic figures with prongs for preforming tie-up practice;
a hard material block with Velcro strip for supporting latex tube fragments (Penrose);
a package of (50) latex tube segments (Penrose) with cuttings for making of sutures and intra- and extra-body knots practice.
a jumbo plastic clamp for support;
alligator-type metal clamps for the same object;
a nylon container bag with zipper.

As can be seen, both the FLS-distributed kit and those from commercial firms, comprise a variety of plastic metal, textile, rubber, etc., materials. Particularly with the FLS kit, a characteristic thereof is that the different components and the assembly manner thereof are provided with a certain degree of standardization in order to comply with pedagogic, evaluation, certification and crediting objects.

In brief, all and each of the models disclosed above as previous art, consist of a hybrid and heterogeneous group of different pieces, made from various materials, some of which are easy to obtain, while other are to be modified, and other ones are of special manufacture. All of them must be grouped into a set of elements suitable to obtain the recited objects, so as to finally be commercialized as a unit.

### SUMMARY OF THE INVENTION

In view of the limitations found in the state of the art, the general object of the present invention is to provide the surgeon with a simple device, ex profeso designed and manufactured, with said device having all the elements needed for the practice and training on the different exercises and maneuvers of laparoscopic, endoscopic or minimal invasion surgeries, mainly those known as basic or fundamental skills or abilities, further to other advanced techniques.

One of the objects of the present invention is to provide a simplified and original alternative for a simulator device for learning and training on basic laparoscopic, endoscopic or minimal invasion surgery techniques.

Another object of this invention is that, contrary to the prior techniques, the present invention has been created ex profeso for a precise purpose, since it is a unique device.

Furthermore, it is an object of the present invention to provide a modular device, constituted by homogeneous parts manufactured from a plastic material suitable for the manipulation thereof.

Another further object of the present invention is to provide an assembling method having a practical purpose and with a specific didactic end that provides utilization improvements.

It is another important object of the present invention to provide a device the parts or components of which can be easily assembled or disassembled into different shapes, as many times as desired, so as to give the user a work station suitable to carry out an exercise or maneuver, such as, among other, cuttings, transference of object, making different types of surgical knots and the application of sutures.

Further to the above recited objects, the present invention offers other important advantages, such as a reduced cost of raw materials, as well as the industrial method of manufacture, with low technology, requiring of low-qualified workmanship.

Likewise it is an object of the present invention to provide a device made from a non-toxic recycled material whereby it is ecologically friendly.

Another further object of the present invention is to provide a device including elements or parts simulating tissues, organs or anatomic structures, also called practice fitting or attachment, which is an essential component in the complete simulation assembly.

It is another object of the present invention that said device is manufactured from a material the physical characteristics of which, such as resiliency, ductility, deformability and strength approach the mean of soft tissues in real surgery, so as to comply with the pedagogic principles of generalization and transfer of capabilities.

Another object of the present invention is to provide a simulator device for learning and training in basic laparoscopic, endoscopic or minimal invasion surgeries, using an assembly method based on temporal connections of the tight assembly or of the “hook and counter” assembly, thus allowing that the configuration adopted is stable and susceptible of being disassembled through the use of a certain force, which intentionally obliges the user to carry out delicate and controlled movements and maneuvers, since, upon the use of an excess of force or rough movements, said device will become disconnected.

Another object of the present invention is that said device, due to the size, dimension and weight thereof, is compatible with and can be integrated into any of the box or “endotrainer” models available.

An additional object of the present invention is that the parts constituting the simulator device have a constant availability of parts or spare parts by virtue of an ample availability of materials and the easy industrial production thereof.

Another object of the present invention is that the simulator device is indistinctly useful for the different techniques and technologies of endoscopic surgery, such as mini-instruments, mechanized sutures, clips and clippers and even the robotic procedures and also the different boarding techniques, such as multiport, one-port, natural orifices (“Notes”), hybrid or even the robotic ones.

A further important object of the present invention is that said simulator device allows the inclusion of other materials or objects, such as animal tissues or viscera for the practice of special exercises, as high-fidelity elements.

Another further object of the present invention is that said simulator device also is capable to test, practice, familiarization and demonstration of new instruments and technologies, as soon as these latter appear in the market.

It is important to point out that the raw material from which the present invention device is made from is of low cost, whereby the production and distribution thereof are made also with a low end price, thus being accessible for both students and already formed professionals and for every type of institutions and economies.

Another characteristic of the present invention is the lightness and portability as well as the hygiene thereof, since it is whole washable and, is ecologically friendly as is made from non-toxic and recyclable materials.

These and other further objects of the present invention will become apparent upon reading the disclosure thereof and the enclosed figures.

### BRIEF DESCRIPTION OF FIGURES

FIG. 1 is a simple perspective view of the base including at least two channeled slots for assembling the pieces, according to the preferred embodiment of the simulator device for laparoscopic, minimal invasion or endoscopic surgeries of the present invention.

FIG. 2 is a simple perspective view of the “U” shaped assembling pieces with fastening hook-shaped point, utilized in other of the work stations of the present invention.

FIG. 3 is a simple perspective view of a comb-shaped part having multiple poles, of the present invention.

FIG. 4 shows the so-called rings, circular elements utilized in one of the training stations.

FIGS. 5, 6, 7, 8 and 9 are simple perspective views of different embodiments of working panels of the device of the present invention.

FIG. 10 is a simple perspective view of the assembly of the base with channeled slots of FIG. 1 and the “U”-shaped assembling pieces with hook-shaped point of FIG. 2 of the present invention.

FIG. 11 shows a simple perspective view of a work station wherein the rings are inserted in perpendicular poles of the present invention.

FIG. 12 is a detailed view showing the hooking of one of the embodiments of panels of FIGS. 5, 6, 7 and 8 of the present invention.

FIG. 13 is a simple perspective view of the coupling at the base of FIG. 1, to the “U”-shaped assembling pieces with fastening hook-shaped point of FIG. 2 and the work panel of FIG. 7, of the device of the present invention.

FIG. 14 is a simple perspective view of the coupling at the base of FIG. 1 to en “U”-shaped assembling pieces with fastening hook-shaped point of FIG. 2, and a further embodiment of the work panel of FIG. 8, of the device of the present invention.

FIG. 15 is a simple perspective view of the coupling at the base of FIG. 1 to the “U”-shaped assembling pieces with fastening hook-shaped point of FIG. 2, and another embodiment of the work panel of FIG. 9, of the device of the present invention.

FIG. 16 is a simple perspective view of the coupling at the base of FIG. 1 to two simple supports suitable for cannulation, suture and anastomosis practices.

### DETAILED DESCRIPTION OF THE INVENTION

The device of this invention for learning and training in basic techniques of laparoscopic, endoscopic or minimal invasion surgery, consists of a series of modules or components that can be assembled with different configurations, in order to assemble or enable different work stations, specific for several practice exercises.

In the following drawings there are illustrated with illustrative, non-limitative purposes the design and configuration of different modules or pieces, as well as the original erecting, mounting and assembling systems of the present invention.

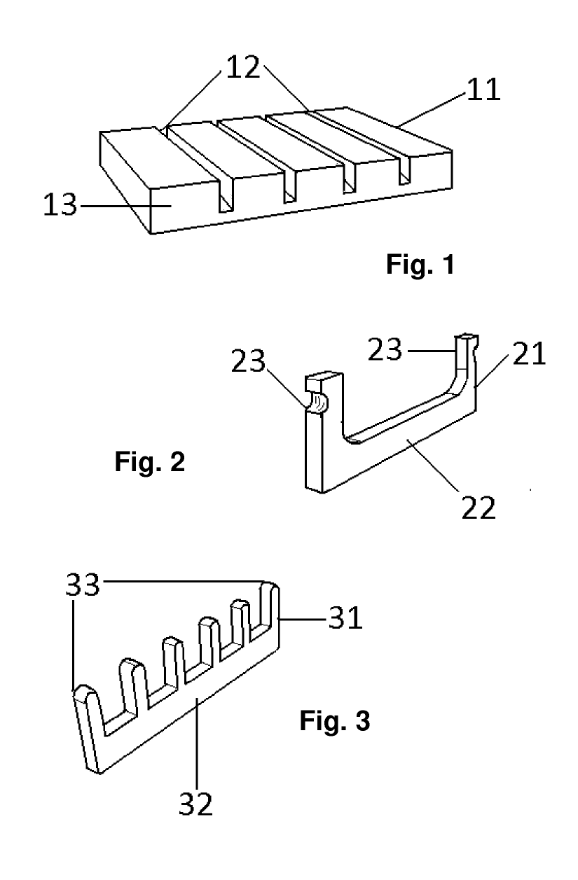

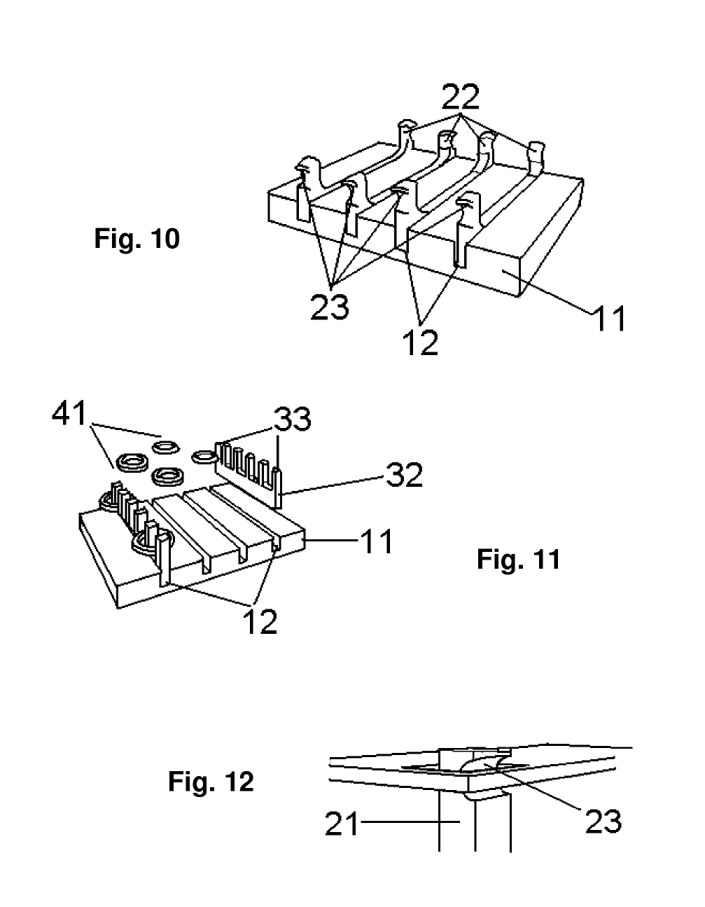

FIGS. 1-9 illustrate separately the pieces; and FIGS. 10, 11, 13, 14 and 15 represent different mounting and erecting embodiments of the working stations of the present invention.

In FIG. 1 a base 11 is shown having a rectangular pyramid shape, with two faces and four sides; said base 11 having the function of support the piece or the pieces of the shape selected by the user; and for that purpose one of its faces has at least two channels or slots 12, preferably parallel to each other, having a breath corresponding to the thickness 13 of base 1, and serving to insert other elements therein, as a dovetail assemble.

FIG. 2 shows a very broad, “U”-shaped panel supporting piece 21 with a horizontal long branch 22 and in one of the ends there of there are two perpendicular branches or short projections, projecting from either end 23 thereof. Likewise, near the points 23 of every short branch, an externally concave hook-like groove 23 can be seen, with said elements 23 being supporting some of the “work panels”, as shown in FIG. 12. The long branch 22 of the support is assembled on the base 11, by fitting in within one of the channels 12, since the thickness 13 of the support and the breath of the corresponding channel have the same dimensions, with the support for panels 21 being used with a kit of two or more units, as shown in FIGS. 10 and 11.

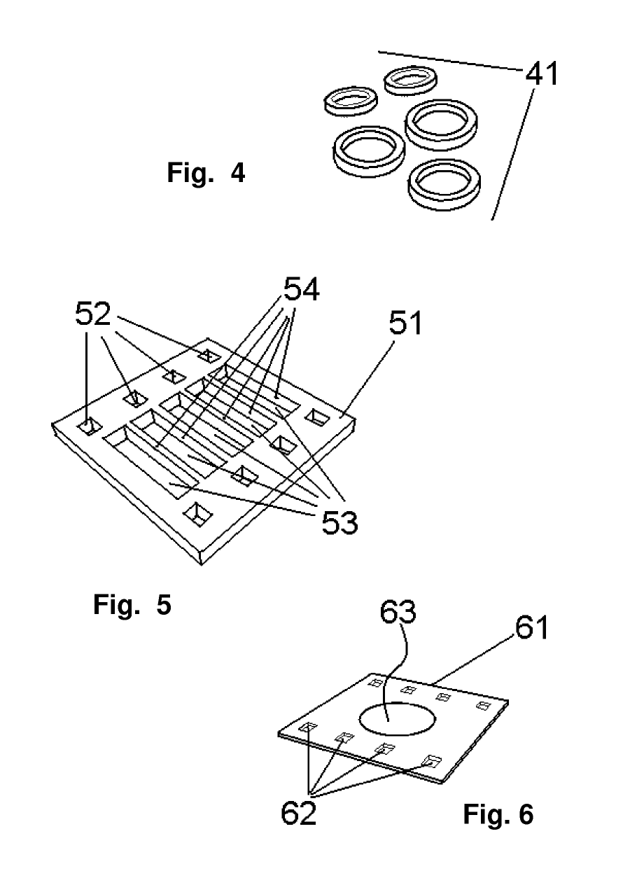

FIG. 3 shows a so-called “comb” or “shell comb” element 31 having a long branch 32 having a plurality of short perpendicular projections 33, projecting from one of the borders thereof, with teeth-like blunt points, the purpose of which is to receive alternatively the rings 41 shown in FIG. 4, during the exercise of transference of objects. As with the support 22 in FIG. 2, the long branch of the “shell comb” 32 is assembled on the base 11, by fitting in within one of its channels 12, as the thickness 32 thereof is equal to the thickness 13 of the corresponding channel 12 of said base 11. Said “shell combs” 31 are utilized also with a kit of at least two pieces, as shown in FIG. 11.

FIG. 4 shows a set of rings 41, the function of which is to be manipulated and transported through the use of laparoscopic clamps and fitted-in in a precise manner, alternatively on the different teeth of the “shell comb” 31 during the object transferring exercise, as can be seen in FIG. 11.

In FIG. 5 an embodiment of a panel 51 is shown from the work panels, whereby the exercises of knots and clips application are carried out. Said “knots panel” 51 is a rectangular or squared, semi-flexible and semi-resilient sheet having near two of its opposite edges, various holes also of square or rectangle form 52, which provide for the fitting in or hooking on the respective “hooks” of said support pieces, as appears in FIG. 12. The “knots panel” 51 also shows several rectangular orifices or recesses 53 separated apart from one another by strips or straps 54, one of which will be surrounded by the thread, string or filament to be knotted through the use of suitable instruments, according to surgical technique, around said strip. Similarly, said strips or straps 54 allow for the practice in application of hemostatic “clips”, by using a suitable instrument.

Likewise, in FIG. 6 an additional embodiment of the work panel 61 is illustrated for the practice of the incising exercise. As in the previous instance, said panel is a semi-flexible and semi-resilient sheet, exhibiting the squared orifices 62 entering the “hooks” in the support, as shown in detail in FIG. 12, and at the center of its faces a drawn or printed FIG. 63 is shown, such as a circle figure, which must be cut on precisely during the corresponding practice, by using a laparoscopic scissors and a laparoscopic support clamp (not shown).

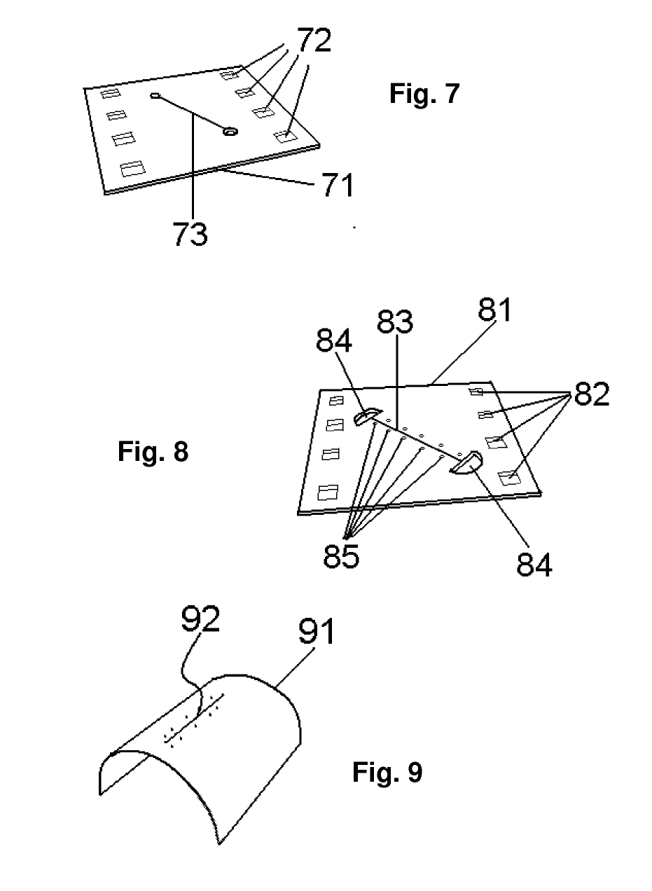

Furthermore, in FIG. 7 other embodiment of the work panel 71 is illustrated for the exercise of suture application. As in the other panels, the insertion holes 72 are shown and at the central portion of said panel 71, a lineal cut 73 is shown, the lips of which are to be “sutured” through the use of a thread or yarn with a semicircular “non-traumatic” surgical needle incorporated therein (not shown) and by using a laparoscopic needle carrier and support clamps (not shown), and making up surgical knots through intra-body or extra-body techniques.

In FIG. 8 another embodiment is shown of the work panel 81, for practicing spiral, wherein, further to the insertion holes 82, there are included a straight lineal cut 83, at the ends of which semi-circular “recesses” 84 and small circular holes 85 are provided a long each of the lips of the central cut. By this means two opposite laps are available. In this practice a segment of two or three wire or plastic spiral loops 141 are passed, as shown in FIG. 14, by alternatively threading through either of holes 85 and by rotating movements, by using needle carrier and laparoscopic clamps (not shown), so as to advance said spiral 141 from one end to another of said lineal cut 83. This is a preparatory exercise for suture application with a needle, so as the practice masters the rotation movements of hands and wrists.

FIG. 9 shows another embodiment of a work panel. This additional embodiment is also a plastic rectangular sheet 91, semi-flexible and semi-resilient. Said characteristics allow for the panel to be bent into an arch in order to take a dome shape, as shown in FIG. 9. Said panel 91 is not provided with insertion holes, as the support thereof is by means of direct assembling of two of the edges thereof into the respective channels 12 of base 11, as illustrated in FIG. 15. This erecting system enable the panel shape of arch or dome. Said panel 91 can be provided of a lineal cut 92 for suture practices or a printed or drawing figure for the incision practice, as shown in FIG. 6

Likewise, FIG. 10 shows four panel supports 22, disclosed with FIG. 2, assembled into the corresponding channels 12 of base 11; with the hook-shaped ends 23 ready to receive a work panel.

FIG. 11 illustrates an exploded view of the device at the working area for the transference of objects. Base 11 is illustrated in said figure, with its channeled areas 12, the shell-comb 32 and rings 41 to be inserted on the respective teeth 33.

Moreover, in FIG. 12 a detailed view is shown of the insertion of a hook 23 of the support piece through the insertion orifices 52, 62, 72 and 82 of the work panel.

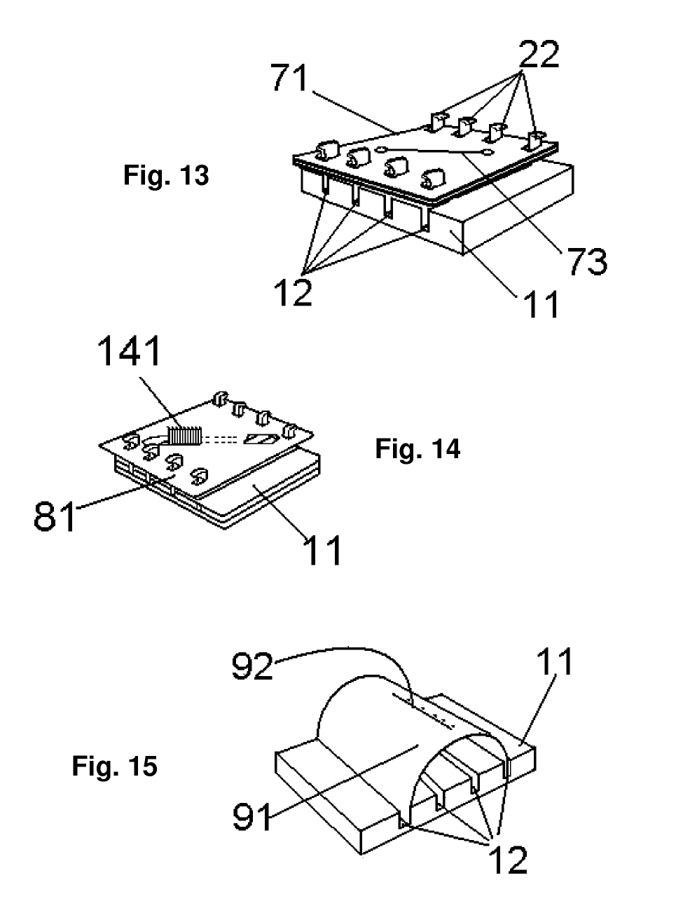

A “suture” practice is illustrated in FIG. 13, with the panel 71 split, stretched and hooked on supports 21 which, in turn, are shown assembled into the channeled base 11.

FIG. 14 shows the spiral practice panel 81, mounted and ready to be used; wherein the channeled base 11 is illustrated, as well as the panel supports 21, the split panel with holes 81 and the spiral 141 threaded into the holes 85 of the laps mentioned in the FIG. 8 description.

In FIG. 15 an embodiment of the panel 91 shown in FIG. 9 is illustrated arched and inserted into channels 12 of base 11, to obtain a work area wherein the incision practice is carried out; said panel 91 including a lineal slot 92.

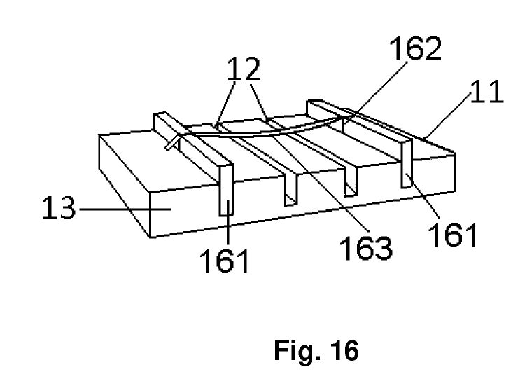

FIG. 16 shows a channeled base 11 with two rectangle shaped simple supports 161 with a transversal slot 162 and with an irregular tubular element 163 pending from and inserted into corresponding support slots, suitable for cannulation and also for suture and anastomosis practices.

### BIBLIOGRAPHY

Review of available methods of simulation training to facilitate surgical education Badma Bashankaev, Sergei Baido, Steven D. Wexner, Surgical Endoscopy (2011) 25:28-35.
Teaching Surgical Skills-Changes in the Wind. Richard K. Resnik & Helen MacRae, New England Journal of Medicine 2006; 355: 2664-9.
Laparoscopic skills training. L. Villegas, B E Schneider, M. P. Callery, D. B. Jones. Surgical Endoscopy (2003) 17: 1879-1888.
Fried G M, Feldman L S, Vassiliou M C, Fraser S A, Stanbridge O, Ghitulescu G, and Andrew C G. Proving the value of simulation in laparoscopic surgery. Ann Surg 2004; 240: 518-528.
Peters J H, Fried G M, Swanstrom L L, Soper N J, Snlin LFSchirmer B, Hoffman K and the SAGES FLS Committee. Development and validation of a comprehensive program of education and assessment of the basic fundamentals of laparoscopic surgery. Surgery 2004; 135: 21-27.
Feldman L S, Hagarty S E, Ghitulescu G, Stanbridge O, Fried G M. Relationship between objective assessment of technical skills and subjective in-training evaluations in surgical residents. J. Am Coli Surg 2004; 198: 105-110.
Fraser S A, Klassen D R, Feldman L S, Ghitulescu G A, Stanbridge O, Fried G M. Evaluating laparoscopic skills; setting the pass/fail score for the MISTELS system. Surgical Endoscopy 2003; 17(6): 964-967.
Derossis A M, Fried G M, Abrahamowicz M, Sigman H H, Barkum J S, Meakins J L, Development of a model for training and evaluation of laparoscopic skills. American Journal of Surgery 1998; Vo. 175: 482-487.
Malheiros Bastos, Erika; Pigozzi Silva Rafael Denadai; Proposal of a synthetic ethylene-vinyl acetate bench model for surgical foundations learning. Suture training. Act. cirurgica Brasileira, vol. 26, No. 26, Sao Paulo, April 2011.
Ramos-Salgado F. et al. Modelo para entrenamiento de cirugìa laparoscòpica urologica. Rev. Mex Urol, 2010; 70(1): 31-35.
Bashankaev B, et al. Review of available methods of simulation training to facilitate surgical education. Surg. Endosc (2011) 25: 28-35.
Ramìrez Solìs M E, et al. Simuladores en la cirugìa endoscòpica en Mèxico, Rev Hosp Gral Dr. M Gea Gonzàlez, vol. 7, No. 3, Septiembre-Diciembre 2006, pàgs. 156-161.
Justo Janeiro, J M. Simuladores para cirugìa endoscòpica. Rev. Mex. Cir. Endosc, Vol. 6, No. 3, 2005; 115-120.
Ramos-Salgado F. et al. Modelo para entrenamiento de cirugìa laparoscòpica urològica. Rev Mex Urol, 2010; 70(1): 31-35.
Hasson, H M et al. Training Simulator for Developing Laparoscopic Skill. JSLS (2001) 5: 255-265.
http://www.flsprogram.org/
http://www.flsprogram.org/up-content/uploads/2010/10/FLSBrochure09 final.pdf
http://www.flsprogram.org/wp-content/uploads/2011/02/FLS order-form 2011.pdf
U.S. Pat. No. 4,321,047 (Landis 1982)
U.S. Pat. No. 4,386,917 (Forrest 1983)
U.S. Pat. No. 4,789,340 (Zikria, 1988)
U.S. Pat. No. 5,230,630 (Burgett, 1993)
PCT WO 93/21619 (1993)
U.S. Pat. No. 5,368,487 (Medina 1994)
U.S. Pat. No. 5,403,191 (Tuason 1995)
U.S. Pat. No. 6,398,557 (Hoballah 2002)
U.S. Pat. No. 6,659,776 B1 (Aumann 2003)
US App Publication No: 2005/0142525 A1 (Coting)
U.S. Pat. No. 6,687,082 B2 (Shun 2005)
International App Publication Number: WO 2005/088583 A1
US 2008/0064017 A1 (Grundmeyer, Raymond III, et al, 2008).
U.S. Pat. No. 7,575,434″″. (Palakodeti 2009)
US App Publication 2009/0142739 A1 (Wang)
U.S. Pat. No. 7,837,473 B2 (Koh 2010)
US App Publication NO: US 2010/0120006 A1 (Bell)

1. A simulator device for training in surgical techniques, such as laparoscopic, endoscopic or minimal invasion, comprising:
a) a base for supporting pieces, with at least two channeled slots;
b) at least two pieces with a plurality of poles in the form of a comb, to be inserted as an assembly into said channeled slots in the base, so as to form different work stations;
c) a set of circular elements, named training rings, in said work stations;
d) at least two “U”-shaped connectable pieces with fastening hook formed point; and
e) a set of work panels, suitable to be mounted on said support pieces or directly on the channeled base; with each of said panels having a specific design dedicated for every particular practice exercise; with said pieces functionally related and coupled to each other; and further by being possible the use thereof separately or jointly in a transitory or permanent manner and under different configurations, by means of several methods, mainly assembles or accouplements and alternatively with other fastening elements or combined therewith.

2. The device according to claim 1, wherein alternative fastening elements can be utilized, such as Velcro-type unions, mechanical fasteners magnetic fasteners or adhesive substances.

3. An erection system for the different pieces of the device according to claim 1, comprising tight assemblies, hook and counter and the like, allowing that the parts constituting said device can be assembled or disassembled easily as many times as desired, into different shapes so as to constitute a work station for the exercise or maneuver to be effected by the user; with said stations having a specific didactic function dedicated to the repetitive execution of every task being effected, by employing suitable surgical instruments, such as:
transfer of objects;
precision incisions;
placing and completion of suture stitches;
forming of surgical knots;
other diverse exercises.

4. The device according to claim 1, made mainly from a soft or semi-rigid plastic material, non-toxic and recyclable.

5. The device according to claim 4, wherein said soft or semi-rigid plastic material preferably is ethyl vinyl acetate (EVA rubber or Foamy).

6. The device according to claim 5, wherein said ethyl vinyl acetate can be utilized together with such materials as textiles, paper derivatives, rubber derivatives, latex terivatives or materials of vegetal or animal origin, and the like.

7. The device according to claim 1, wherein different work stations enable the exercise of incision techniques, transference of object, forming of different types of surgical knots and application of sutures and other exercises.

8. The device according to claim 1, wherein said device, thanks to its size, dimensions and weight, can be integrated in any commercial or handcraft box or endotrainer model.

9. The device according to claim 1, wherein said device allows the use of different techniques and technologies of endoscopic surgery, such as: mini-instruments, mechanized sutures, clips and clippers, robotic procedures and varied boarding techniques, such as multiport, one-port, through natural orifices, also known as “Notes”, hybrid and robotic techniques.

10. The device according to claim 1, wherein said device is capable of mounting animal tissues or viscera in the practice of special exercises.

11. The system according to claim 3, having the characteristic of being light and portable, as well as washable and ecologically friendly.
